(19) United States
(12) Patent Application Publication
(10) Pub. No.: US 2012/0247643 A1
(43) Pub. Date: Oct. 4, 2012

(54) TAPE FLAW AND SPLICE AVOIDANCE

(75) Inventor: Robert A. Kramp, Bonney Lake, WA (US)

(73) Assignee: THE BOEING COMPANY, Chicago, IL (US)

(21) Appl. No.: 13/448,360

(22) Filed: Apr. 16, 2012

Related U.S. Application Data
(63) Continuation-in-part of application No. 11/261,362, filed on Oct. 28, 2005, now Pat. No. 8,158,210.

(51) Int. Cl. B32B 41/00

(52) U.S. Cl. 156/64; 156/350

(57) ABSTRACT

A method comprises forming a composite layup, including dispensing fiber material; and monitoring the dispensed material prior to laydown for a marker. The marker provides information about an upstream location of the material. The forming further includes using the information in the marker to adjust material course length to control where the upstream location will be deposited, if at all.

This is a continuation-in-part of U.S. Ser. No. 11/261,362 filed Nov. 28, 2005, now U.S. Pat. No. 8,158,210.

### BACKGROUND

Layup machines may be used to fabricate complex composite structures such as aircraft wings and fuselages. These layup machines form layups by depositing reinforcing fibers on layup surfaces (e.g., surfaces of layup mandrel tools and flat tables). Examples include automated tape lamination (“ATL”) machines, which deposit fiber material as wide tape, and automated fiber placement (“AFP”) machines, which deposit fiber material as tows or narrow slit tape.

Fiber material may be supplied to a layup machine on spools. During material laydown, fiber material is dispensed from a spool, and an application head moves along a layup surface and deposits and compacts one or more bands of the material on the surface per pass. ATL machines typically deposit one band of tape per pass. AFP machines typically deposit multiple bands (e.g., 24 or 32) per pass. The application head may make multiple passes over the layup surface in a pre-defined pattern, building up layers of the fiber material until a layup has been formed.

The fiber material on a spool may contain defects, or it may be spliced together after defective material has been removed. These splices can result in random and unpredictable process interruptions during tape laydown, causing down time during which the machine is stopped, a partial course is manually removed, and the machine is restarted. Additionally, reaching the end of the spool unexpectedly can cause similar problems. Consequences include production delays, material waste, and higher labor costs. Material waste is compounded if wider materials are used (e.g., 12″ wide versus 6″ wide).

It would be desirable to avoid the production delays, material waste, and higher labor costs.

### SUMMARY

According to an embodiment herein, a method comprises forming a composite layup, including dispensing fiber material; and monitoring the dispensed material prior to laydown for a marker. The marker provides information about an upstream location of the material. The forming further includes using the information in the marker to adjust material course length to control where the upstream location will be deposited, if at all.

According to another embodiment herein, a method comprises depositing fiber material onto a layup surface while monitoring the material to be deposited for discontinuity markers. Each marker provides information about location of a detected upstream discontinuity. The method further comprises using the information in each marker that is detected to control where the detected discontinuity will be deposited, if at all.

According to another embodiment herein, a layup machine comprises an application head for receiving fiber material and depositing the material; a detector for detecting markers on the fiber material; and a controller for using information conveyed by the detected markers to control the application head to avoid depositing upstream discontinuities or control placement of the upstream discontinuities.

These features and functions may be achieved independently in various embodiments or may be combined in other embodiments. Further details of the embodiments can be seen with reference to the following description and drawings.

### BRIEF DESCRIPTION OF THE DRAWINGS

FIG. 1 is an illustration of fiber material having markers.

FIG. 2 is an illustration of fiber material with markers on a removable backing.

FIG. 3 is an illustration of fiber material having multiple line markers.

FIG. 4 is an illustration of fiber material having coded data markers.

FIG. 5 is an illustration of a method marking flaws or splices on fiber material.

FIG. 6 is an illustration of a method of forming a layup of fiber material.

FIG. 7 is an illustration of a system for forming a composite layup.

FIG. 8 is an illustration of a control system of the system of FIG. 7.

FIG. 9 is an illustration of an application head of the system of FIG. 7.

FIG. 10 is an illustration of examples of options for the control system of FIG. 8.

### DETAILED DESCRIPTION

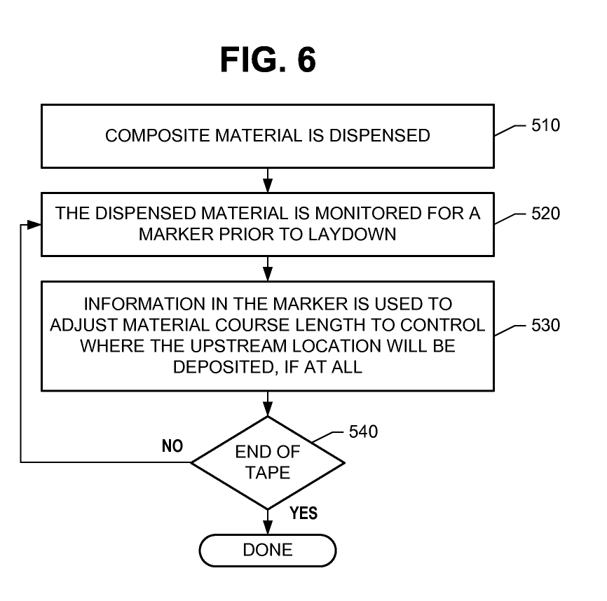

Reference is made to FIG. 6, which illustrates a method of using a layup machine to form a layup of fiber material. The material may be deposited in multiple courses per ply and multiple plies. As used herein, a course refers to the width of material laid in a single pass of the application head. A course may include one or more bands of tape or tows deposited per head excursion.

At block 510, the fiber material is dispensed. For instance, if the fiber material is supplied to an ATL machine as a tape roll, the tape is unwound from the roll and fed to a tape placement head of the ATLmachine.

At block 520, the dispensed material is monitored for a marker prior to laydown on a layup surface. The marker provides information about an upstream location of the material. The information might include, as examples, the location of a splice, a flaw, or a spool end.

At block 530, the information in the marker is used to adjust material course length to control where the upstream location will be deposited, if at all. As a first example, the marker indicates a distance to the upstream location, and that distance is compared to the next course to be deposited. If the distance is greater than the length of the next course, then the next course will be defect-free. Then the next course is deposited.

As a second example the distance to a defect is shorter than the length of the next course to be deposited, and that next course is not allowed to contain a defect. If an alternate course is available, the tape may be applied along that alternate course.

As a third example, the distance to a defect is shorter than the length of the next course to be deposited, and the defect will occur in a certain portion of the layup. If certain conditions are satisfied, however, the fiber material may be deposited in that portion. Part designers may allow very minor material defects to exist in that portion or prove that minor anomalies in that portion are harmless. For example, they may allow a small gap between fibers that resulted during the tape manufacturing process in a region. They may allow certain anomalies to be deposited, provided that those anomalies are not concentrated in a particular or critical area of the layup.

As a fourth example, the distance to a defect is shorter than the length of the next course to be deposited, no alternate courses are available, and the part cannot contain any defects. Therefore, the portion of the fiber material containing the defect is dispensed and scrapped.

Application heads that feed and compact the fiber material may be equipped with cutters that cut the material to desired length. In certain ATL machines, the cutters cut the fiber material against backing paper before the paper has been separated from the fiber. In certain AFP machines, guillotine type cutters cut fiber material after it has been removed from the backing material but before just before compaction device and before it is compacted onto the layup surface.

The functions at blocks 520 and 530 may be repeated for each additional marker that is detected (block 540). By finding alternate courses for the fiber material prior to laydown, instead of scrapping fiber material that has already been deposited, the cost of labor and material is reduced, and the number of process interruptions is reduced.

The markers are placed on the fiber material prior to being supplied to the layup machine. For instance, the markers may be placed on the material by the manufacturer of the fiber material or by a vendor of the fiber material manufacturer. In the paragraphs that follow, different embodiments of spools of marked fiber material will be described.

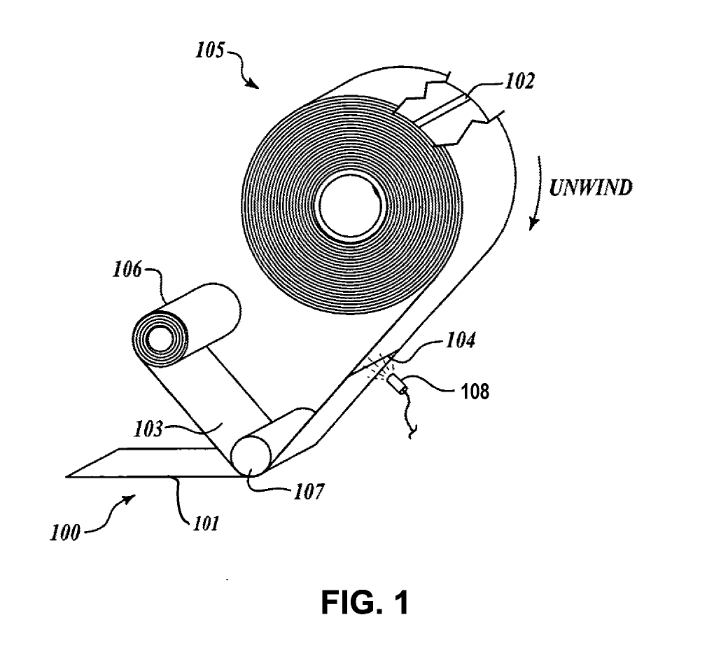

FIG. 1 illustrates a roll 105 of composite tape 100 including carbon fibers 101 or any other suitable fibers. In this embodiment, the tape 100 has a removable backing portion 103 (e.g. backing paper).

One or more markers 104 are provided on the carbon fibers 101. The markers 104 are provided at specified distances from a particular upstream location 102 (e.g., flaw or splice as shown in the cutaway portion of FIG. 1), and each marker 104 indicates the location of the upstream location 102 relative to the marker 104. As the tape 100 is unwound for use, the markers may be detected in advance of the upstream location 102. The markers 104 may be formed using an ink, a paint, or any other suitable coating or material, and may be any suitable color or opacity that may be detected (visibly or non-visibly) during the unwinding of the roll 105 of tape 100. In some embodiments, the markers 104 are formed using ink and may be applied using an inkjet printer. In other embodiments, the markers 104 may be formed manually using a marking pencil or other suitable device or material. In still other embodiments, other printing or labeling technology such as laminating, embossing, stamping, or etching may be used. The processes and materials used to form the markers 104 may be selected based on the tape materials and manufacturing process specifications involved in the manufacturing operation.

The markers are not limited to any particular type. For example, the markers may include letters, numbers, symbols, or other graphics, whether individually or in conjunction, may be used as markers to represent distances to upstream locations. Another example, described below, is a bar code.

As the tape 100 is unwound from the tape roll 105, it is deposited by a compaction roller or other pressing device 107, while a take up reel 106 winds up the removable backing portion 103. A sensor 108 monitors the carbon fibers 101 for the presence of a marker 104.

One or more markers 104 may be placed at a distance from the upstream location 102 that is greater than a longest required tape course (e.g. a length of tape sufficient to wind one revolution around a mandrel, or the length of a layup mandrel tool, workpiece, or other suitable body or distance). This ensures that an adequate length of the tape 100 sufficient for any tape course is always available.

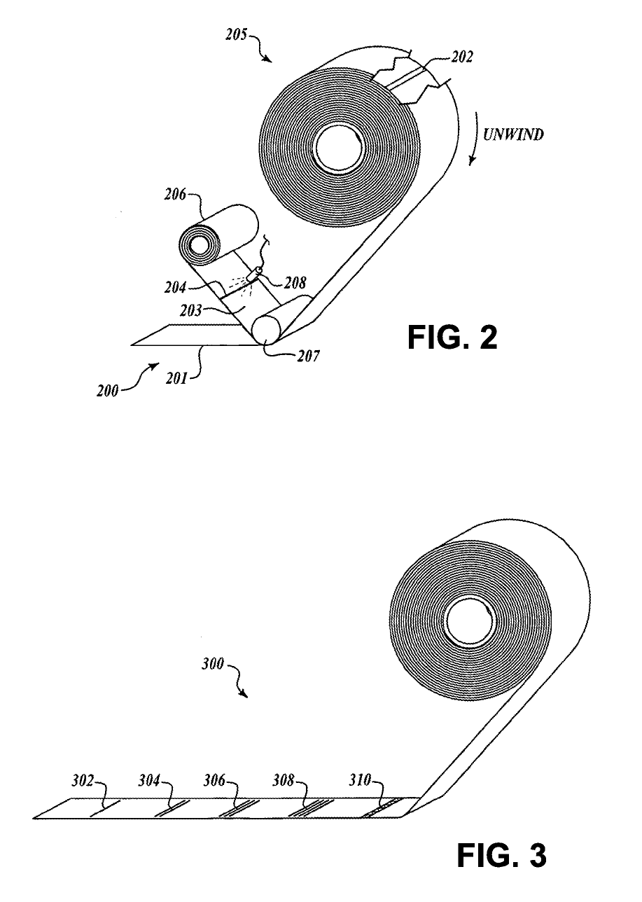

FIG. 2 illustrates a roll 205 of composite tape 200 having a composite portion 201 and a removable portion 203. One or more markers 204 are placed on the removable portion 203 of the composite tape 200. Each marker 204 indicates an upcoming location of a splice or flaw 202 (show in the cutaway portion of FIG. 2). A compaction roller or other pressing device 207 presses against the removable portion 203 to apply the composite portion 201 to a workpiece.

In some embodiments, the tape 200 has removable coverings on both sides of the composite portion 201. For example, the tape 200 may have a backing paper on one side of the composite portion 201 and a plastic film layer on the other side. In such cases, the markers 204 may be placed on any of these coverings.

The markers 204 placed on the removable portion 203 may be detected by a sensor 208 during the application process as the tape 200 is unwound from the tape roll 205 and as the removable portion 203 is collected by a take up reel 206. The type of sensor 208 will depend upon the type of marker 204. In some embodiments, the sensor 208 may include a camera, a barcode reader/scanner, or any other suitable sensor. In other embodiments, metal sensing sensor may be used to detect metallic markers, photoelectric and photographic sensors may be used to detect high contrast markers (e.g. black on white, barcode readers used with barcodes etc.).

In some embodiments, the tape may have single marker for a corresponding location. In other embodiments, the tape may have multiple markers for each location.

FIG. 3 illustrates a tape roll 300 having multiple line markers. In this embodiment, a first marker is a single line 302, followed by a sequence of additional markers that are groupings of two lines 304, then three lines 306, then four lines 308. The groupings of lines serve to “count down” the tape length as the tape is dispensed from the roll and the flaw or splice approaches. Each type of line groupings may represent a discrete distance to a flaw or splice location 310. For example, a single line 302 can represent a first distance (e.g. 100 feet) to the flaw or splice 310, double lines 304 can represent a second distance (e.g. 75 feet) to the flaw or splice 310, and triple lines 306 can represent a third distance (e.g. 50 feet) to the flaw or splice 310, and so on and so forth. In alternate embodiments, different types of markers (other than groups of parallel lines) may be used to indicate different distances to the upcoming slice or flaw. For example, the different markers might consist of different line thicknesses, line colors, patterns, symbols, or any other suitable types of markers. The use of more than one different type of marker upstream of a flaw or splice may further reduce the likelihood that lost tape length may result in unreliability of flaw or splice avoidance features.

In some embodiments, the markers may include additional information. For instance, a marker herein may include a barcode, a data matrix or other similar coded mark that contains more data than just a marker line.

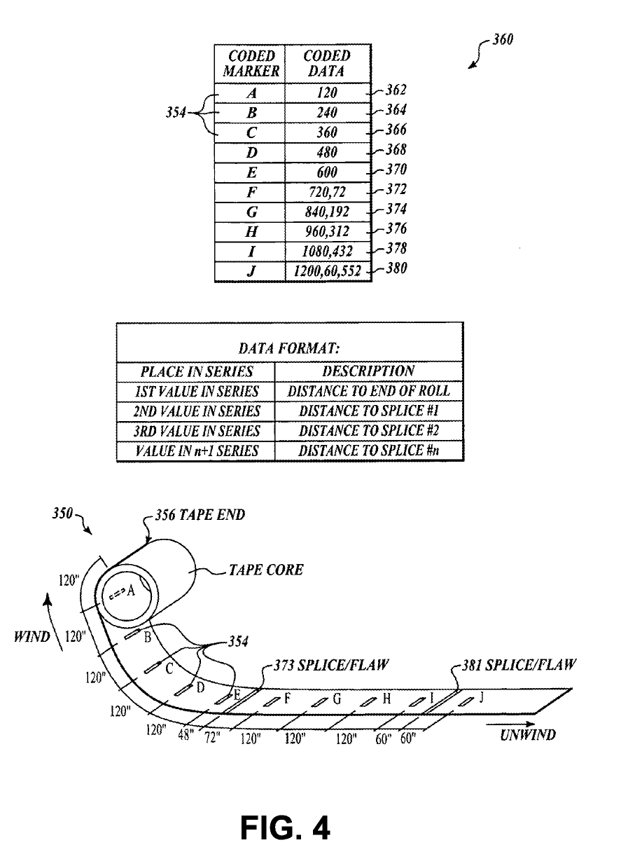

Reference is made to FIG. 4, which illustrates tape 350 having coded data markers 354. Some or all of the markers 354 may be located relative to a single reference location, such as the trailing end of the roll 356, and the markers 354 may be spaced at some regular interval from there. By using markers 354 that can contain more coded information, each marker 354 may contain enough data to represent the cumulative information about locations of all splices, flaws and the roll end that would exist downstream of each and every mark read.

More specifically, as shown in a first table 360 in FIG. 4, a first coded marker A provides a first coded data 362 indicating a distance of 120 units to the tape end 356. Similarly, a second, third, fourth and fifth coded markers B, C, D, and E, provide second, third, fourth, and fifth coded data 364, 366, 368, 370 indicating distances to the tape end 356. A sixth coded marker F, however, provides a sixth coded data 372 that indicates both a distance to the tape end 356 (i.e. 720 units) and also another distance to a first splice (or flaw) 373. A seventh, eighth, and ninth coded markers G, H, I, provide seventh, eighth, and ninth coded data 374, 376, 378 which also indicate two distances, specifically a distance to the tape end 356, and another distance to the first splice (or flaw) 373. A tenth coded marker J provides a tenth coded data 380 that indicates a distance to the tape end 356, another distance to the first flaw 373, and yet another distance to a second flaw 381. As shown in a second table 385 (FIG. 4), this pattern of markers 354 and coded data may extend indefinitely along the tape 350.

Each marker 354 may advantageously provide the layup machine with an updated distance from it to the upstream location. The markers 354 need not contain the information about splice locations. Since one problem with prior art systems and methods is that accurate reference to the splice location gets lost routinely, embodiments herein may overcome this problem by providing an accurate position reference to the end of the roll that can be refreshed repeatedly by the reading marker (barcode) position data. Less data may be required to be contained at each marking in this case and this may make finding a reliable code format easier. Each time that a barcode is read it would send the distance from it to the trailing tape end position that is coded into it to the control. Splices/flaws locations would also be defined by their distance from the trailing end but entry of this data would be a separate operation from reading the barcode markings and making the tape position updates. Having the information carried in the markers 354 throughout the length of the tape roll may advantageously allow the controller to find discrete positions within the tape roll with some accuracy.

Fiber tows and slit tape may be marked according to any of the embodiments above. The fiber tows may be so marked even though they are generally narrower than tape, have different process specifications and engineering properties and allowable, different packaging (e.g., wound helically), and are cut differently (machine processing methods for fiber placement usually cut the ends of bands of materials with a perpendicular cut to the fibers to form crenulated ply boundaries whereas tape being wider is cut to a detailed shape that matches and follows closely to the ply boundary definition).

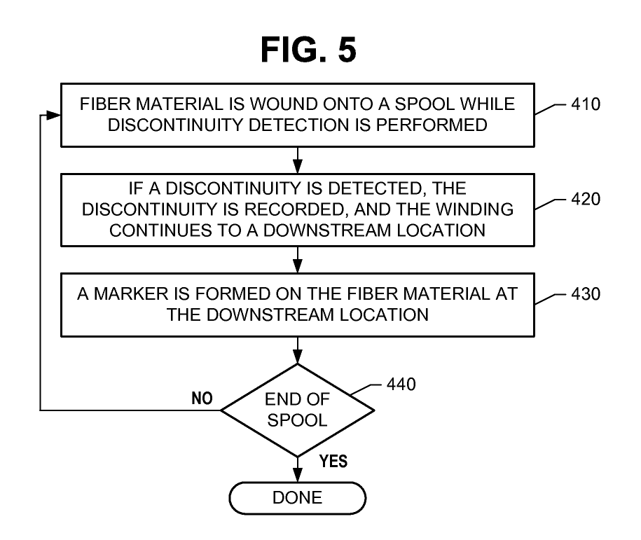

Reference is now made to FIG. 5, which illustrates a method of marking defects on fiber material. At block 410, the fiber material is wound onto a spool or other suitable holding device. The winding is performed from the end of the material to the beginning (that is, the opposite direction during laydown). As the fiber material is being wound, any splices, defects, cuts or other discontinuities are detected.

If a discontinuity or other anomaly is detected, it is recorded, and the winding continues to a downstream location (block 420). At that downstream location, a marker is formed on the fiber material (block 430). For instance, if each marker is supposed to indicates a distance of 100 feet to a discontinuity, another 100 feet of the fiber material will be wound and the a marker will be formed on the fiber material. A marker may be formed as the fiber material is being wound, or the winding of the fiber material may be temporarily suspended as a marker is being formed.

The functions at blocks 410 to 430 are repeated until the end of the spool (or some other termination criteria) has been reached (block 440).

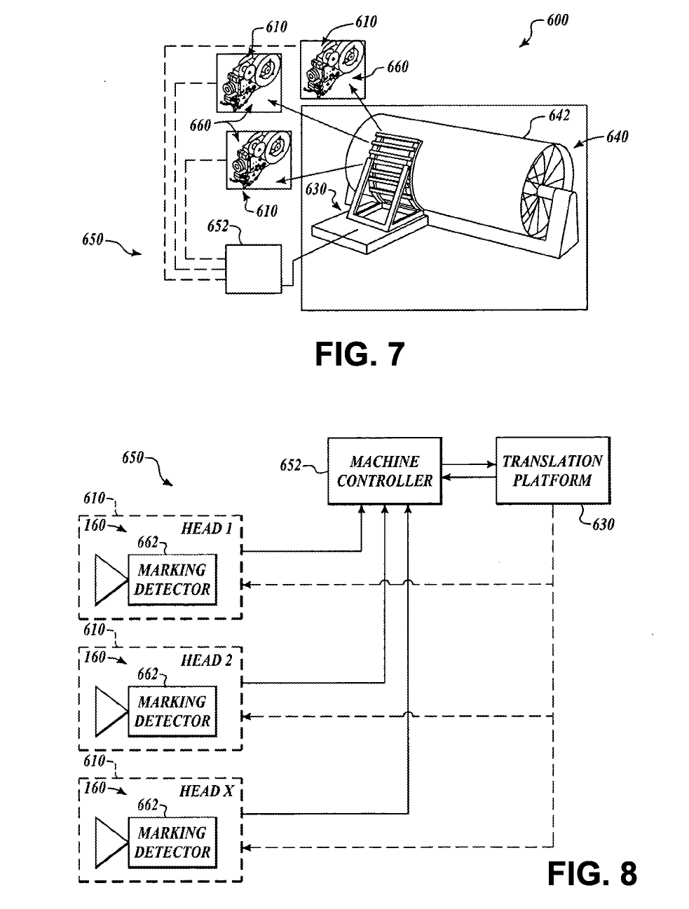

Reference is now made to FIG. 7, which illustrates an ATL system 600 for depositing the marked composite tape. The system 600 includes a plurality of head assemblies 610 coupled to a translation platform 630 and operatively positioned proximate a layup mandrel tool 640. The translation platform 630 is adapted to systematically move the head assemblies 610 along three-dimensional paths proximate the tool 640, and each head assembly 610 is operable to perform placement and consolidation of the marked tape to produce a composite layup 642.

In some embodiments, the system 600 may include a multi-head tape lamination machine (MHTLM). FIG. 7 shows a system 600 including three head assemblies 610. However, a system herein is not limited to three head assemblies 610.

FIG. 8 illustrates a control system 650 for the system 600 of FIG. 7. The control system 650 includes a machine controller 652 for executing a control code that transmits control signals to the translation platform 630 and the head assemblies 610. The control signals command the movement and functions of the translation platform 630 and the head assemblies 610, thereby causing automated (or semi-automated) manufacturing of the laminated composite layup 642 on the tool 640.

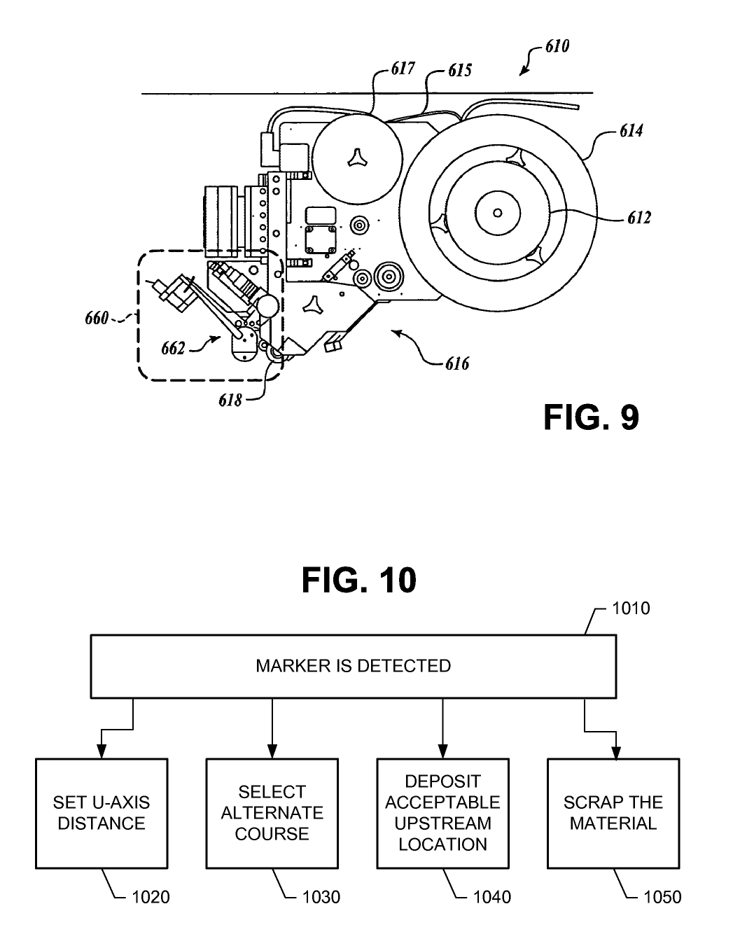

FIG. 9 illustrates an example of a head assembly 610. In this example, the head assembly 610 includes a spindle 612 configured to retain a roll 614 of the marked composite tape 615. A feed assembly 616 is configured to receive, guide, and apply the tape 615 from the roll 614 onto the layup 642. More specifically, the feed assembly 616 includes a feed roller 617 that receives the tape 615 from the roll 614, and a compaction roller 618 that applies and compacts the tape 615.

The head assembly 610 further includes a sensor unit 660 configured to detect the markers on the composite tape 615. As best shown in FIG. 9, the unit 660 includes a detector 662 positioned to view a portion of the tape 615 proximate the compaction roller 618, prior to the tape 615 being applied and compacted. The sensor unit 660 may be adapted to acquire and analyze signals from the marking detector 662 to determine the presence of markings on the tape 615, or alternately, the signals may be transmitted to the controller 652.

Each sensor unit 660 is coupled to the machine controller 652. Communication between the sensor unit 660 and the controller 652 may be accomplished by standard Ethernet connections, or alternately, by a custom network or server. Communication may also be achieved through a wireless network that utilizes spread spectrum RF to overcome sources of interference in a typical factory environment.

During operation, as the head assemblies 610 deposit the composite tape 615, the sensor units 660 monitor the tape 615 for the presence of markings, the sensor units 660 detect a marker on the tape 615, and transmits an indicator signal to the machine controller 652. Alternately, the machine controller 652 may receive raw signals from the sensor units 660 and perform the marker detection.

Reference is now made to FIG. 10, which illustrates examples of options that are available to the control system 650 when a marker is detected on the tape 615 (block 1010). Examples of the options include, but are not limited to at least one the following.

At block 1020, an operator sets an accessible variable, called U-axis distance to splice position, to match the marker to flaw or splice distance. For instance, a control variable set by an operator might define the longest course in a part layup. Then the system would stop the process and alert the operator to the fact that a splice is in the material within the longest course distance. With this information, an operator would make a human based decision about what to do to minimize the impact of the splice. For example, the operator may decide to lay some shorter courses out of order to maximize use of available material in front of the splice.

At block 1030, an alternate course is selected, whereby the courses are reordered. The controller 652 compares next course length to the distance to the upstream location, and identifies an alternate course. For instance, a search of the control code or a part program may be performed. The search will scan all course lengths remaining to be laid within a current ply to find one or more courses of suitable length that can be laid down with the tape length that is available before encountering the flaw or splice. The controller 652 may also be configured to search for courses in other non-overlapping plies. For example, it could search for courses in multiple small, non-overlapping plies distributed within a layup boundary. The controller 652 may even be configured to scan a group of courses such that order of laying the group of courses would be chosen to minimize the impact of a splice or flaw. The laying sequence in the part program would then be automatically reordered by the controller 652 to maximize use of tape that is available in front of the splice.

At block 1040, the controller 652 determines whether the upstream location is acceptable in the region in which it will be deposited (e.g., whether the region is allowed to contain a defect). If the upstream location is acceptable, the tape is deposited at the next course.

At block 1050, the controller 652 scraps the fiber material. For instance, the upstream location is in a region that must be defect free, and no alternate courses are available.

1. A method comprising forming a composite layup, including:
dispensing fiber material;
monitoring the dispensed material prior to laydown for a marker, the marker providing information about an upstream location of the material; and
using the information in the marker to adjust material course length to control where the upstream location will be deposited, if at all.

2. The method of claim 1, wherein the fiber material is tape.

3. The method of claim 1, wherein the fiber material is in the form of tows.

4. The method of claim 1, wherein the marker is detected before the fiber material is deposited.

5. The method of claim 1, wherein the marker is detected on a removable layer.

6. The method of claim 1, wherein the marker information identifies the upstream location of at least one of a flaw, splice, cut, and roll end.

7. The method of claim 1, wherein using the information includes comparing distance to an upstream location to length of an alternate course.

8. The method of claim 1, wherein using the information includes setting a U-axis distance.

9. The method of claim 1, wherein using the information includes depositing the upstream location in a region that allows anomalies.

10. The method of claim 1, wherein using the information includes selecting and depositing an alternate course, whereby course reordering is performed.

11. The method of claim 10, wherein the alternate course lies in a different ply.

12. The method of claim 1, wherein using the information includes selecting an alternate group of courses.

13. The method of claim 1, wherein a plurality of markers are provided for the upstream location; and wherein monitoring the fiber material includes using the markers to update the distance to the upstream location.

14. A method comprising:
depositing fiber material onto a layup surface while monitoring the material to be deposited for discontinuity markers, each marker providing information about location of a detected upstream discontinuity; and
using the information in each marker that is detected to control where the detected discontinuity will be deposited, if at all.

15. A layup machine comprising:
an application head for receiving fiber material and depositing the material;
a detector for detecting markers on the fiber material; and
a controller for to using information conveyed by the detected markers to control the application head to avoid depositing upstream discontinuities or control placement of the upstream discontinuities.

16. The system of claim 15, wherein the controller is configured to perform course reordering if a marker is detected.

17. The system of claim 15, wherein the controller is configured to control the application head to deposit an upstream discontinuity in an allowable region.

18. The system of claim 15, wherein the controller is configured to process a marker that includes a plurality of approximately parallel lines.
